(19) United States
(12) Patent Application Publication
(10) Pub. No.: US 2002/0034612 A1
(43) Pub. Date: Mar. 21, 2002

(54) Plastic sideboards for the transportation equipment industry

(76) Inventor: Thomas J. Knutson, Dickinson, ND (US)

Correspondence Address: CHASE & YAKIMO, L.C., 4400 COLLEGE BOULEVARD, SUITE 130, OVERLAND PARK, KS, 66211

(21) Appl. No.: 09/884,251

(22) Filed: Jun. 19, 2001

Related U.S. Application Data
(60) Provisional application No. 60/212,515, filed on Jun. 19, 2000.

(51) Int. Cl. B32B 3/20

(52) U.S. Cl. 428/188; 428/122

(57) ABSTRACT

A plastic sideboard for the transportation equipment industry that is lighter in weight than wood or steel sideboards, does not require painting or weatherproofing, will not split or splinter from use, and will not rust, warp, break or bend. The inventive device includes a main board section that may be formed in various heights or than can be stacked to increase overall dump box height, a top rail section that may be rounded to prevent materials from collecting on the top edge, and a bottom rail section that facilitates stable and proper placement of the sideboard into any conventional sideboard bracket. The plastic resin used can be of various chemical components with varying durometers. The plastic sideboard and components may be formed of various color plastics to match the vehicle color.

### CROSS-REFERENCE TO RELATED APPLICATION

This application claims the benefit of co-pending provisional application Serial No. 60/212,515, filed Jun. 19, 2000.

### FIELD OF THE INVENTION

The present invention relates generally to sideboards for the transportation equipment industry, and more specifically it relates to a plastic sideboard that is lighter in weight than wood or steel sideboards, does not require painting or weatherproofing, will not split or splinter from use, and will not rust, warp, break or bend.

### DESCRIPTION OF THE PRIOR ART

Sideboards for dump trucks and similar vehicles in the transportation industry have been in use for years. Typically, sideboards are comprised of wood, steel or recycled plastic. A significant problem with conventional sideboards is that wooden sideboards are prone to warping, splitting, splintering, and are easily damaged by loaders. Steel sideboards are prone to rust, are significantly heavier than conventional wooden sideboards, and if bent or distorted are difficult to repair. Both wood and steel sideboards require periodic painting or other maintenance. Recycled plastic sideboards are prone to warp and break because they are made from heterogeneous plastic which often contains dissimilar plastic materials as well as impurities. These materials are not suitable for providing a sideboard to the transportation equipment industry that will not warp, split, splinter, rust, bend or break from use.

### SUMMARY OF THE INVENTION

In view of the foregoing disadvantages inherent in the known types of sideboards present in the prior art, the present invention provides a new plastic sideboard for the transportation equipment industry that is lighter in weight than wood or steel sideboards, does not require painting or weatherproofing, will not split or splinter from use, and will not rust, warp, break, or bend.

The present invention generally comprises a main board section that can be fabricated in various heights or that can be stacked to increase overall height in use, a top rail section that is typically rounded to prevent materials from collecting on the top edge of the sideboard, and a bottom rail section that facilitates stable and proper placement of the sideboard into any conventional sideboard bracket. The top and bottom rails are constructed of plastic resin formed generally into a teardrop shaped cross-section. The bottom rail is typically constructed in a tapered design to provide for a stable footprint and to prevent materials from collecting on the sideboards. The plastic resin used to form the top and bottom rails can be of various chemical components with varying durometers. The top and bottom rails may be grooved to accept the main board section. The main board section is honeycombed with longitudinally extending channels to reduce weight and it provides the height and rigidity required to hold materials within the vehicle.

The present invention is not limited in its practice to the details of construction and to the arrangements of the components set forth in the following description or illustrated in the drawings. The present invention is capable of other embodiments and of being practiced and carried out in various ways. The terminology employed herein is for the purpose of description and should not be regarded as limiting except as used in the claims.

A primary object of the present invention is to provide a plastic sideboard for the transportation equipment industry that will overcome the shortcomings of the prior art devices.

Another object of the present invention is to provide a plastic sideboard for transportation equipment that is lighter in weight than wood or steel sideboards, does not require painting or weatherproofing, will not split or splinter from use, and will not rust, warp, break or bend.

Another object is to provide a plastic sideboard for transportation equipment wherein the main board is comprised of unrecycled (virgin) plastic.

Another object is to provide a plastic sideboard for transportation equipment that will resist damage when struck by materials being loaded or unloaded.

Another object is to provide a plastic sideboard for transportation equipment that will resist damage when hit by the bucket of a front end loader or other loading machinery.

Another object is to provide a plastic sideboard for transportation equipment that will be an attractive add-on to the truck box or dump box and will remain attractive throughout the life of the sideboard.

Another object is to provide a plastic sideboard for transportation equipment that will reduce or eliminate the costly downtime of putting a dump truck or trailer into the maintenance shop for the removal and replacement of sideboards.

Another object is to provide a plastic sideboard for transportation equipment that is lighter in weight than wooden or steel fabricated sideboards.

Other objects and advantages of the present invention will become obvious to the reader and are within the scope of the present invention.

To accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is a cross-sectional view of the plastic sideboard assembly.

FIG. 2 is a perspective view of the plastic sideboard assembly.

FIG. 3 is a cross-sectional view of the top rail.

FIG. 4 is a cross-sectional view of an alternative embodiment of the top rail.

FIG. 5 shows cross sectional views of alternative embodiments of the bottom rail.

FIG. 6 is a perspective view of the top rail.

FIG. 7 is a perspective view of the bottom rail.

FIG. 8 is a cross-sectional view of the main board.

FIG. 9 is a perspective view of the main board.

FIG. 10 is a diagrammatic view of the sideboard prior to installation on a dump truck.

FIG. 11 is a diagrammatic view of the sideboard installed on a dump truck.

FIG. 12 is a side elevation of the sideboard assembly including a tapered end.

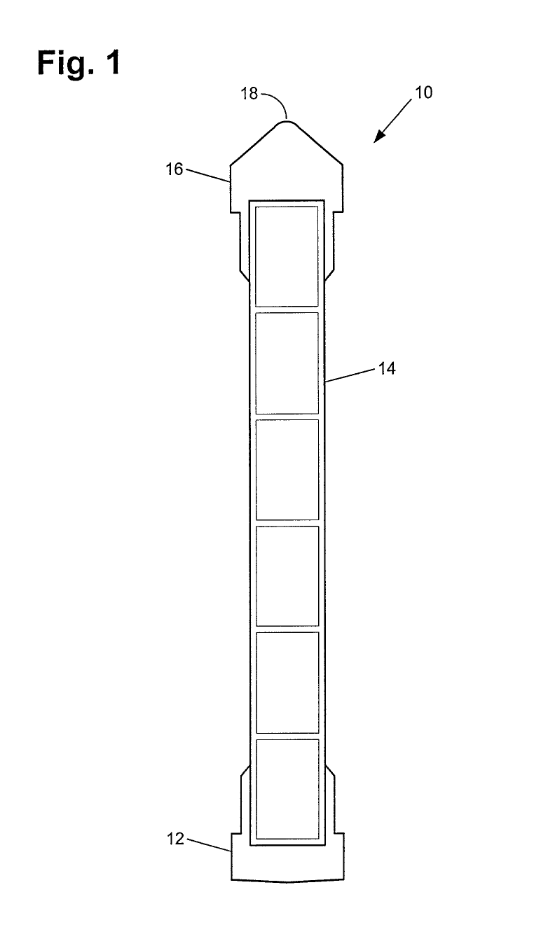

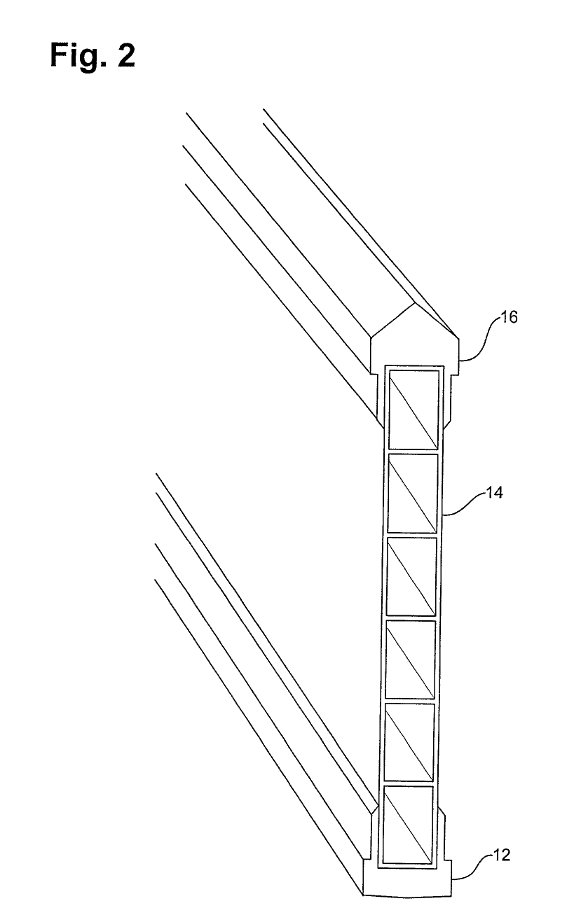

### DESCRIPTION OF THE PREFERRED EMBODIMENT

The attached figures illustrate the present invention, a plastic sideboard 10 for use on a dump truck 50 or other transportation equipment. The present invention comprises a main board 14 that may be fabricated in various heights or that can be stacked to increase overall height, a top rail 16 that may be rounded at the top surface 18 to prevent materials from collecting on the top rail 16, and a bottom rail 12 that facilitates stable and proper placement of the sideboard into any conventional sideboard bracket 54. These components may be fabricated in varied colors to match the color of the vehicle on which the sideboard 10 is mounted.

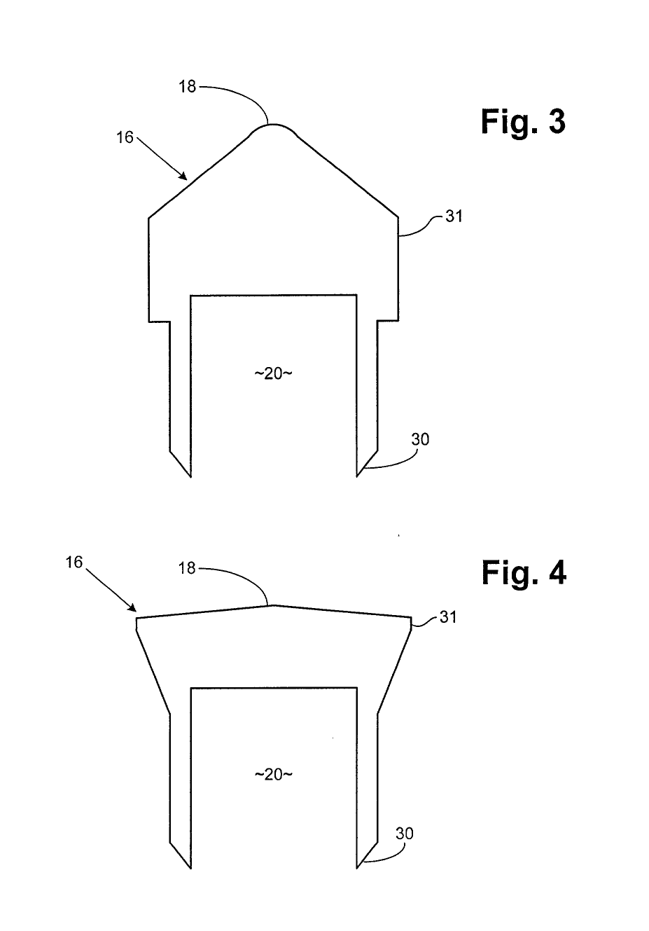

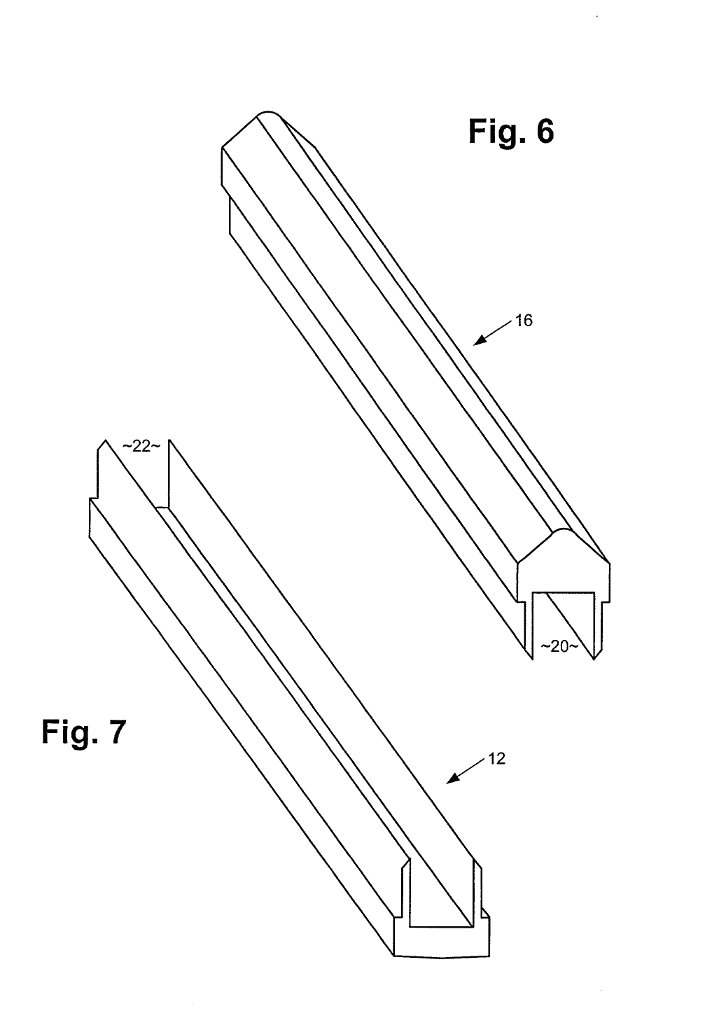

The top rail 16, as illustrated in FIGS. 3 and 6, is constructed of plastic resin formed into an elongated member with an approximately teardrop shaped cross-section presenting a narrow end 30 and an opposing wide end 31. Along the narrow end 30 there is a longitudinal groove 20. The wide end 31 is rounded 18 to prevent material from collecting on the top rail 16.

The top rail 16 is manufactured by means of a plastic extrusion process using a blend of plastic resins. The top rail 16 can be manufactured using plastic materials of various chemical compositions depending on the characteristics desired. The specific durometer of the top rail 16 can be changed in the extrusion process to achieve specific end user requirements. The top rail 16 can be produced in a variety of colors in order to match the color scheme of the vehicle. The top rail 16 may be shaped to avoid the collection of materials on the sideboard, to match the thickness dimension of a standard piece of 2× construction lumber, and to accept the matching fit of the main board 14.

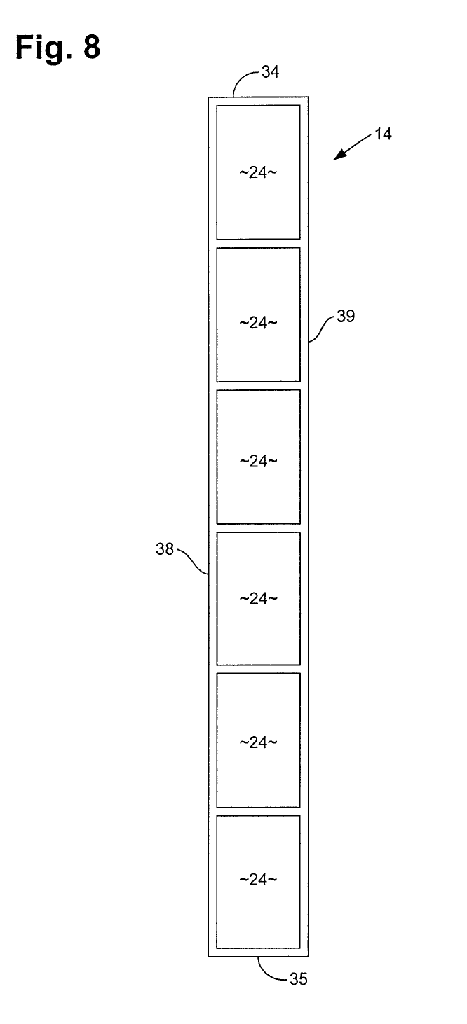

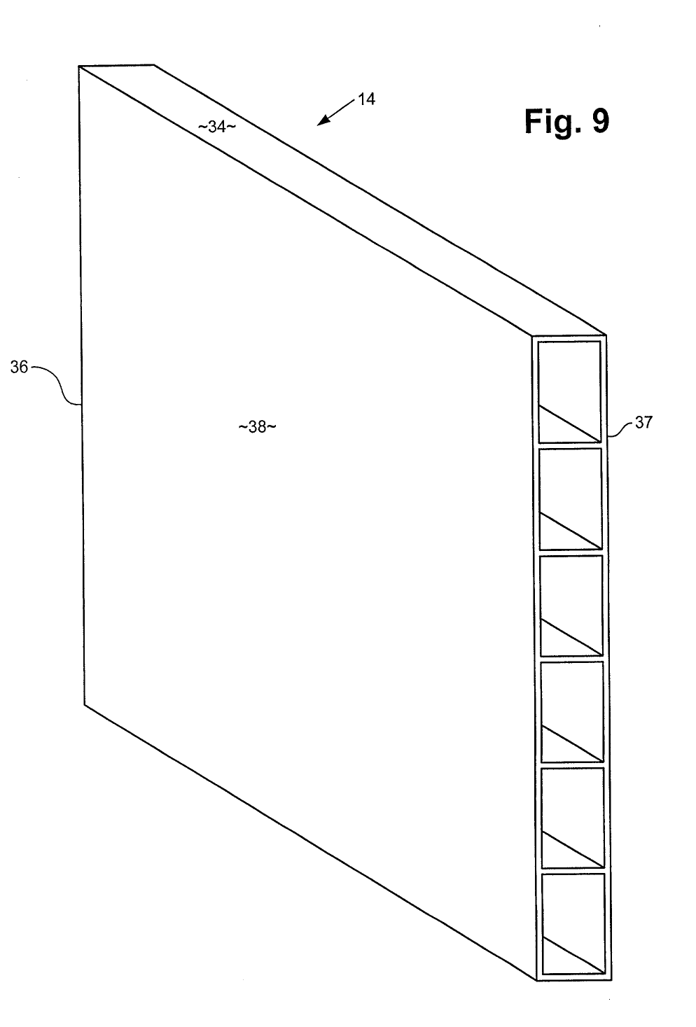

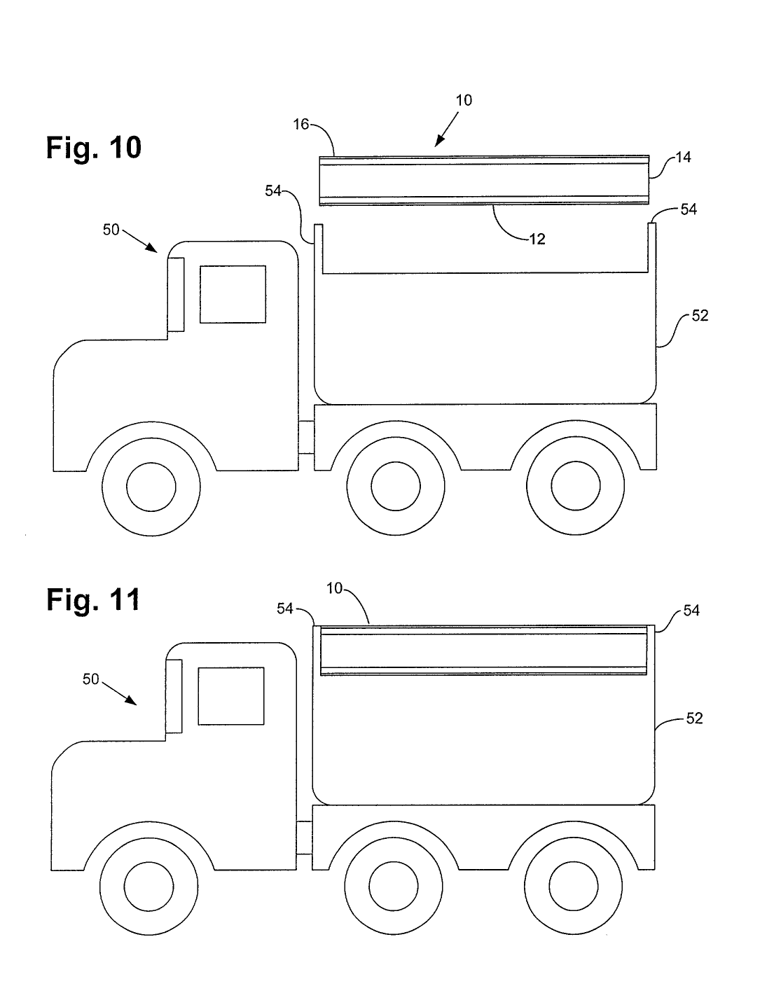

The main board 14, as illustrated in FIGS. 8 and 9, is elongated with narrow opposing top 34 and bottom 35 edges and narrow opposing left 36 and right 37 end edges, and two opposing flat front 38 and back 39 sides yielding a rectangular cross-sectional profile. Longitudinal hollow channels 24 within the main board 14 form a honeycombed interior. The honeycomb design of the main board 14 creates rigidity along the length of the sideboard 10 while decreasing overall weight. The main board 14 is manufactured by means of a plastic extrusion process using a blend of virgin plastic resins, and may be produced in various heights and lengths to fit varying dump truck 50 dimensions. The main board 14 provides the height and rigidity required to hold materials within the dump truck box 52, FIGS. 10-11. The main board 14 can be altered in material thickness, height, and structural design by the modification of the extrusion tooling (not shown). The main board 14 is formed to fit into the matching sections of the top rail 16, and the bottom rail 12. The color and material type of the main board 14 can be changed to match the needs of the end user.

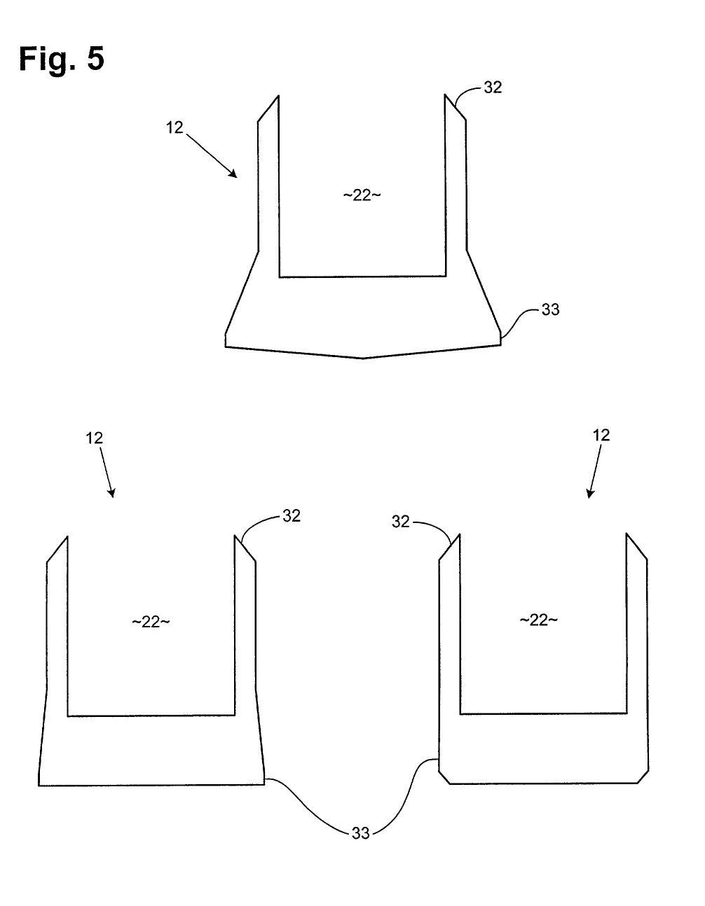

The bottom rail 12, as illustrated in FIGS. 5 and 7, is constructed of plastic resin in a tapered design to provide for a stable footprint and to prevent materials from collecting on the sideboard 10. The bottom rail 12 is an elongated member with an approximately teardrop shaped cross-section presenting a narrow end 32 and an opposing wide end 33. Along the narrow end 32 there is a longitudinal groove 20. The base dimension of the bottom rail 12 approximates the width of a standard piece of 2× construction lumber. The channel 22 of the bottom rail 12 is designed specifically to fit the insertion of the main board 14.

The cross-sectional design of the top rail 16, bottom rail 12 and main board 14 can be changed by the modification of tooling attached to the extrusion machine. Alternatively, the sideboard 10 may be fabricated as a single extruded piece incorporating either or both rail profiles at the main board 14 edges. The main board 14 may also be fabricated at a width to fit the sideboard brackets without use of a bottom rail 12.

The top rail 16 and bottom rail 12 may be grooved to accept the main board 14. The three sub-components, the top rail 16, the bottom rail 12, and the main board 14 may interconnect in a similar manner to tongue and groove construction. Alternative fasteners can be used to secure the components to each other such as screws, machine bolts and nuts, plastic plugs, or rivets (fasteners not shown). A permanent assembly can be made by application of plastic adhesive (not shown) to the articulating surfaces of the main board 14 and rail sections 12 and 16.

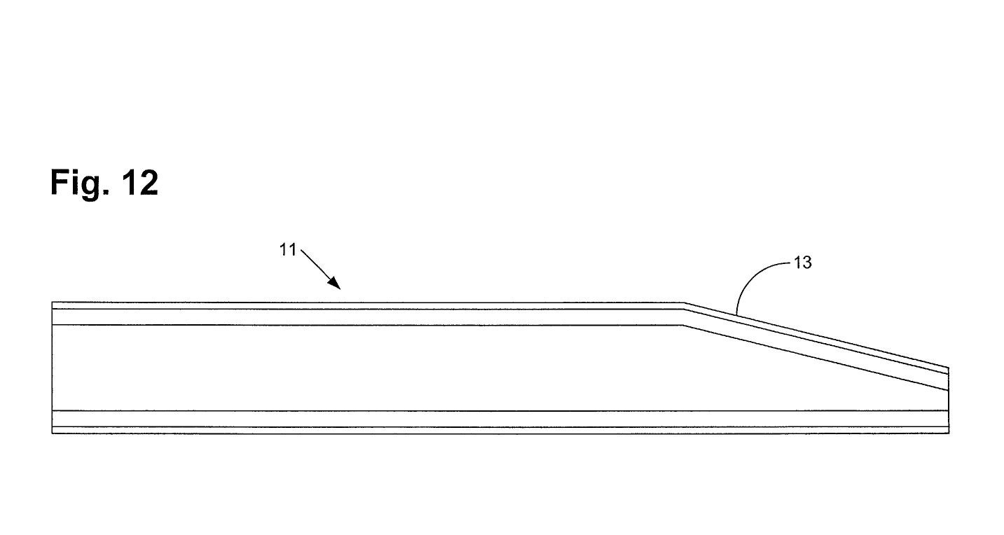

The top rail 16 serves as a protective device to prevent damage caused by contact with loading machinery, or materials being loaded or unloaded. The bottom rail 12 provides a base to contact the surface of the vehicle on which it is installed and to provide a cushion to protect the main board 14. The most common sideboard 10 lengths vary between eight feet and sixteen feet, however, they may be produced in any length required. Because the sideboard 10 of the present invention is constructed of plastic, a rotary saw or jigsaw can be used to cut the material to length. The plastic sideboard 10 can also be used in a tapered configuration 11 simply by cutting the main board 14 to the desired amount of taper and installing the top rail 16 on the tapered portion 13, FIG. 12.

The sideboard 10 operates as a protective bumper for the dump box 52 by absorbing impacts from front end loaders and other similar loading devices (not shown). The sideboard 10 is able to withstand the abuse of loading devices but is able to flex sufficiently to avoid damage to the sideboard brackets 54 that are attached to the dump box 52. The sideboard 10 also serves as an extension to the dump box 52 to increase load capacity. The sideboard 10 also serves as a decorative trim attachment for the dump box 52 to enhance the image of the entire vehicle 50. The sideboard 10 can also be used on pickup beds, trailers, and other transportation equipment for increased capacity and to enhance the image of the vehicle.

The foregoing is illustrative of the principles of the present invention. Since numerous modifications and changes may readily occur to those skilled in the art, it is not desired to limit the invention to the exact construction and operation shown and described.

What is claimed is:

1. A plastic sideboard for transportation equipment comprising:
an elongated main board formed of extruded plastic and having a generally rectangular cross-sectional profile, a narrow top edge and an opposing narrow bottom edge;
longitudinal hollow channels within said main board defining a honeycombed interior;
an elongated top rail formed of extruded plastic; and
means for securing said top rail to said top edge of said main board.

2. The sideboard of claim 1 wherein a plurality of main boards are stacked vertically to achieve a desired sideboard height, said top rail secured to the topmost main board.

3. The sideboard of claim 1 further comprising:
an elongated bottom rail formed of extruded plastic; and
means for securing said bottom rail to said bottom edge of said main board.

4. A plastic sideboard for transportation equipment comprising:
an elongated main board formed of extruded virgin plastic and having a generally rectangular cross-sectional profile, a narrow top edge, and an opposing narrow bottom edge;
longitudinal hollow channels within said main board defining a honeycombed interior;
an elongated bottom rail formed of extruded plastic and having a generally teardrop shaped cross section presenting a narrow end and a wide end, said narrow end including a three walled longitudinal groove of dimensions to receive said bottom edge of said main board;
an elongated top rail formed of extruded plastic and having a generally teardrop shaped cross section presenting a narrow end and a wide end, said narrow end including a three walled longitudinal groove of dimensions to receive said top edge of said main board, said wide end having a rounded outer surface to prevent material from collecting on said top rail;
means for securing said top rail to said top edge of said main board; and
means for securing said bottom rail to said bottom edge of said main board.

5. The sideboard of claim 4 wherein said top rail, said bottom rail and said main board are comprised of unrecycled plastic.

6. The side board of claim 4 wherein said top rail and said bottom rail are comprised of recycled plastic.

7. The sideboard of claim 4 wherein said top rail and said bottom rail are each respectively secured to said main board at said top edge and said bottom edge by rivets passing through walls of said longitudinal grooves and also through main board, said rivets being spaced intermittently along the length of said sideboard.

8. The sideboard of claim 4 wherein said top rail and said bottom rail are each respectively secured to said main board at said top edge and said bottom edge by plastic plugs passing through said walls of said longitudinal grooves and also through the main board, said plastic plugs being spaced intermittently along the length of said sideboard.

9. The sideboard of claim 4 wherein said top rail and said bottom rail are each respectively secured to said main board at said top edge and said bottom edge by bolts passing through said walls of said longitudinal grooves and also through the main board, said bolts threadably secured in place by nuts, said nuts and bolts spaced intermittently along the length of said sideboard.

10. The sideboard of claim 4 wherein said top rail and said bottom rail are each respectively secured to said main board at said top edge and said bottom edge by adhesive.
